(19) United States
(12) Patent Application Publication
(10) Pub. No.: US 2003/0160016 A1
(43) Pub. Date: Aug. 28, 2003

(54) Mobile tower crane

(76) Inventors: Eduardo Ortiz, Leander, TX (US); Jean-Paul Verchere, St. Nizier (FR)

Correspondence Address: BRINKS HOFER GILSON & LIONE, P.O. BOX 10395, CHICAGO, IL, 60610, US

(21) Appl. No.: 10/085,470

(22) Filed: Feb. 28, 2002

(51) Int. Cl. B66C 23/42

(52) U.S. Cl. 212/300

(57) ABSTRACT

A mobile tower crane for lifting a load, wherein the mobile tower crane comprises a jib supported by a mast, the jib being swingable about a vertical axis of the crane. The mobile tower crane further comprises a hoisting block for lifting the load, wherein the hoisting block is suspended from a trolley by a load hoist line, and the trolley is movable along the length of the jib. Wherein the mobile tower crane further comprises a commercially available truck for supporting the mast, and the mast and the jib can be collapsed on top of the commercially available truck for transport between job sites.

### BACKGROUND OF THE INVENTION

The present application relates to construction equipment, such as cranes. In particular, the present application relates to a self-erecting mobile tower crane that has been mounted on a commercial built truck chassis, and which complies with U.S. Department of Transportation and State highway and bridge limits.

A typical tower crane has a horizontal jib that is supported by a vertical mast. Loads are lifted by a load hoist hook that is suspended from a trolley connected to the underside of the jib. The trolley is movable along the length of the jib so as to move the load hoist hook, and any load suspended thereby, horizontally relative to the mast of the crane. The load hoist hook is connected to a load hoist line that is extended or retracted to lower or raise the load hoist hook relative to the jib.

In some types of tower cranes, the jib is rotatably mounted to the top of a stationary mast. In these types of tower cranes, a slewing ring is mounted between the top of the mast and the jib. The slewing ring permits the jib to rotate relative to the mast, thereby permitting loads to be moved in a radial direction relative to the stationary mast. These types of cranes are often referred to as top slewing tower cranes.

In other types of tower cranes, the mast is rotatably mounted on the base of the crane. In particular, the slewing ring is mounted between the bottom of the mast and the base of the crane. In these types of tower cranes, the jib is fixed to the top of the mast in such a manner as to prevent the jib from rotating relative to the mast. The slewing ring permits the mast and jib to rotate as a single unit relative to the base of the crane. These types of cranes are often referred to as bottom slewing tower cranes.

Construction equipment, such as tower cranes, must often be moved from one job site to another. Typically, the tower crane is disassembled into smaller, more easily handled components. The individual crane components are then transported to the new job site where they are reassembled. Disassembling, moving, and reassembling a tower crane can be a complicated and time-consuming task. In addition, it is often necessary to utilize a separate assist crane to assemble and disassemble the tower crane.

Consequently, there has been an effort to develop tower cranes that are more easily transported between job sites. There has also been an effort to develop tower cranes that can be disassembled and reassembled without the use of an assist crane. These efforts have resulted in the development of mobile self-erecting tower cranes. However, the mobile self-erecting tower cranes that have been developed thus far have a number of limitations and drawbacks.

For example, most of the mobile self-erecting tower cranes that have been developed thus far are mounted on a transport trailer. These types of tower cranes therefore require a separate transport vehicle to tow the transport trailer between job sites. Moreover, the transport trailer for these types of tower cranes, by itself, is usually insufficient to support the crane. Thus, a complicated support structure, as well as supplemental counterweights, is usually required to stabilize the crane.

Some mobile self-erecting tower cranes have also been developed for mounting on specially designed truck chassis. Because the truck chassis are uniquely designed for each specific tower crane, they are expensive and time-consuming to design and manufacture. Moreover, the truck mounted tower cranes that are currently available have been designed for the European market, and therefore fail to comply with U.S. Department of Transportation Federal Highway and Bridge limitations, as well as similar State limitations.

Another limitation of the previously developed mobile self-erecting tower cranes is the requirement for supplemental electrical power. For example, most mobile self-erecting tower cranes require three-phase electrical power to operate. With respect to most mobile self-erecting tower cranes, the required three-phase electrical power is typically supplied through the transmission lines of the local electrical power company. These transmission lines may be costly and time-consuming to install, or may not even be available at the job site. Alternatively, an engine-powered generator set located at the job site may supply the required three-phase electrical power.

It is therefore desirable to provide a self-erecting mobile tower crane that can be transported between job sites with minimal, if any, disassembly, and which can be transported in compliance with State and U.S. Department of Transportation Federal Highway and Bridge limitations. It is also desirable to provide a self-erecting mobile tower crane that has been mounted on a commercially available truck chassis. It is also desirable to provide a self-erecting mobile tower crane that does not require a separate source of electrical power for supplying the electrical power necessary to operate the crane.

### BRIEF SUMMARY OF THE INVENTION

In preferred aspects, the present invention comprises a self-erecting mobile tower crane that can be transported between job sites with minimal, if any, disassembly, and which can be transported in compliance with U.S. Department of Transportation Federal Highway and Bridge limitations. The invention further comprises a self-erecting mobile tower crane that has been mounted on a commercially available truck chassis.

In particular, the present invention comprises a mobile tower crane having a tower crane portion mounted on the truck chassis of a commercially available truck. The tower crane portion comprises a rotating bed supported on the truck chassis by a slewing ring, a mast supported on the rotating bed, and a jib supported by the mast. The jib supports a movable trolley, and a hoisting block is suspended from the trolley by a load hoist line. A load hoist hook is connected to the hoisting block and is used to connect to the load to be lifted by the crane.

The jib is swingable about the vertical axis of rotation of the rotating bed so as to move the load hoist hook in a horizontal arc about the axis of rotation. The trolley is movable along the jib so as to move the load hoist hook in a horizontal direction perpendicular to the axis of rotation. The hoisting block is movable relative to the trolley so as to move the load hoist hook in a vertical direction parallel to the axis of rotation. In addition, the tower crane portion is collapsible to a transport position on top of the commercially available truck for transport between job sites.

The mobile tower crane of the present invention has the advantage of being built on a commercially available truck. Accordingly, the cost and time of manufacture can be substantially reduced, particularly since the tower crane portion can be mounted on truck chassis from different commercial manufacturers depending on the availability and design criteria.

The mobile tower crane of the present invention also has the advantage of being collapsible to a transport position that will comply with State and U.S. Department of Transportation Federal Highway and Bridge limitations.

These and other advantages, as well as the invention itself, will become apparent in the details of construction and operation as more fully described and claimed below. Moreover, it should be appreciated that several aspects of the invention can be used with other types of cranes, machines or equipment.

### BRIEF DESCRIPTION OF SEVERAL VIEWS OF THE DRAWINGS

FIG. 1 is a right side elevational view of a mobile tower crane in accordance with the teachings of this invention. The mobile tower crane is shown in the fully erected, normal operational position, with the jib being shown in both the unfolded and partially folded positions.

FIG. 2 is a partial right side elevational view of the upper portion of the mobile tower crane wherein the jib is in a 20° offset work position, with the jib being shown in both the unfolded and partially folded positions.

FIG. 3 is a left side elevational view of the mobile tower crane in the transport position.

FIG. 4 is a schematic showing the mobile tower crane in various stages of erection between the transport position shown in FIG. 3 and the operational position shown in FIG. 1.

FIG. 5 is a schematic showing the mobile tower crane in various stages of erection between the transport position shown in FIG. 3 and the 20° offset work position shown in FIG. 2.

### DETAILED DESCRIPTION OF THE INVENTION

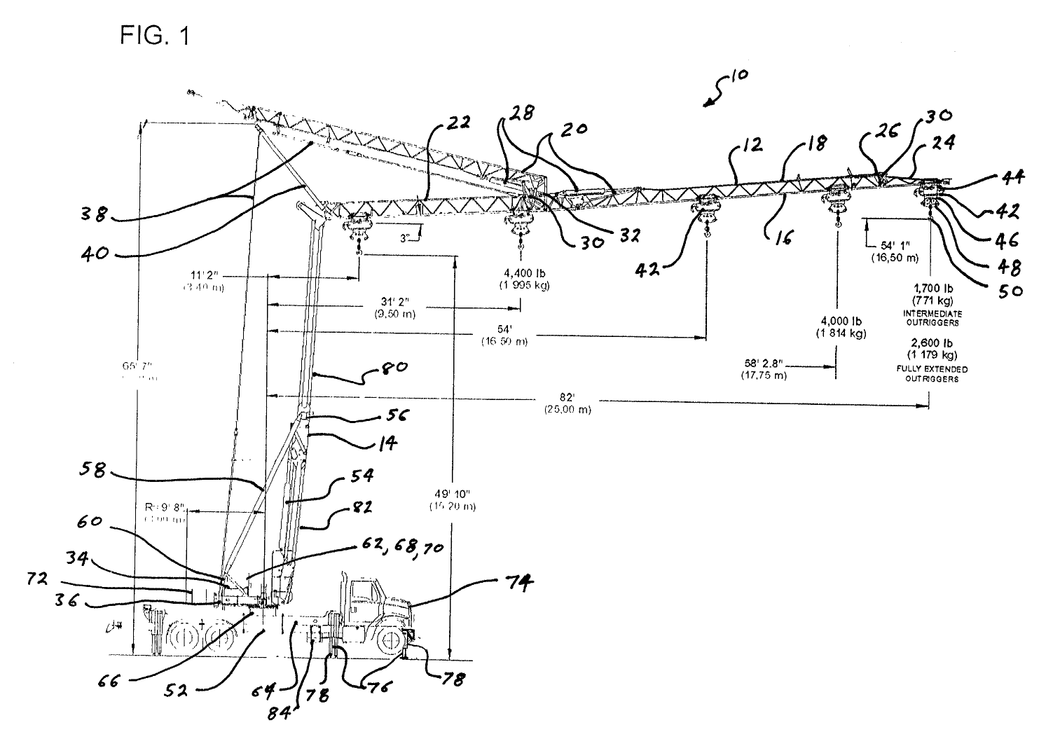

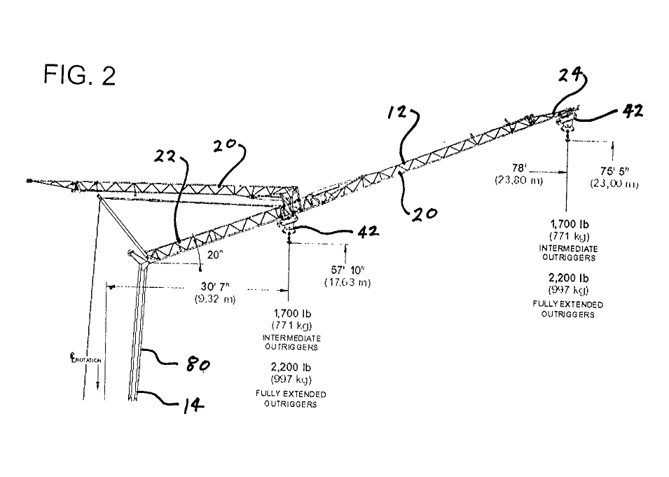

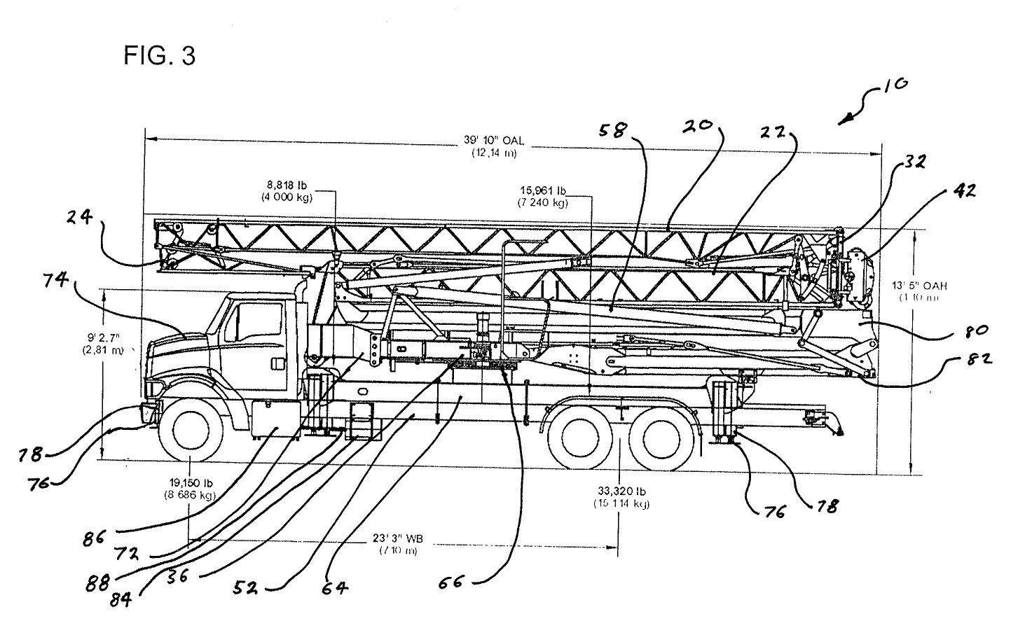

While the present invention will find application in many types of mobile cranes or construction equipment, the preferred embodiment of the invention is described in conjunction with the mobile tower crane 10 of FIG. 1. The mobile tower crane 10 includes a jib 12 that is pivotally mounted on a mast 14. The pivotal connection between the jib 12 and the upper end of the mast 14 is oriented horizontally so as to permit the vertical angle between the jib 12 and the mast 14 to be changed. For example, the angle of the jib 12 can be changed between the normal operational position (shown in FIG. 1) and the 20° offset work position (shown in FIG. 2). As will be explained in more detail below, the pivotal connection between the jib 12 and the mast 14 also permits the jib 12 to be folded and collapsed on top of the mast 14 for transport (as shown in FIG. 3).

In the preferred embodiment shown, the jib 12 comprises lattice structure formed of steel angles and/or steel tubular members. The lattice structure of the jib 12 preferably has a triangular cross-section with two lower cord members 16 and one upper chord member 18. In the preferred embodiment shown, the lower cord members 16 and the upper chord member 18 each comprise a tubular steel member and the lacing members comprise steel angles. However, and as appreciated by those knowledgeable in the art of cranes, cross-sections can be utilized depending on the design and loading parameters of the jib 12. For example, the jib 12 could comprise a rectangular cross-section having two lower cord members 16 and two upper chord members 18. The jib 12 may also be manufactured from other types of materials such as aluminum. The jib 12 of the preferred embodiment provides a load radius of 82 ft.

The jib 12 preferably comprises three sections that can be folded to reduce the overall length of the jib 12 (see FIG. 3). For example, the forward jib section 20 can be folded back on to the rearward jib section 22 to substantially reduce the length of the jib 12 so as to avoid structures or buildings within the working radius of the mobile tower crane 10. It should be observed that FIGS. 1 and 2 show the jib 12 in both the fully extended position and in the partially folded position. In particular, the forward jib section 20 is simultaneously shown in these two figures as forwardly extending in line with the rearward jib section 22 (i.e., the fully extended position), and as rearwardly extending above the rearward jib section 22 (i.e., the partially folded position).

The jib 12 is also foldable so as to reduce the length of the jib 12 for transport (as shown in FIG. 3). In the preferred embodiment shown, the longest section of the jib 12, which is the forward jib section 20, is less than 39 ft. 10 in. so as to comply with applicable State and U.S. Department of Transportation Federal Highway and Bridge limitations. As will be explained in greater detail below, many States, including California, limit the overall length of fixed chassis vehicles to no more than 40 ft. Therefore, the folded jib 12 must be less than this length to comply with these State's roadway limitations.

Of course, it should be appreciated that a jib 12 having a shorter overall length (when fully erected) may only require two foldable sections to meet the above roadway limitations. Likewise, a jib 12 having a longer overall length may require more than three foldable sections to meet these same limitations, or to meet more restrictive roadway limitations.

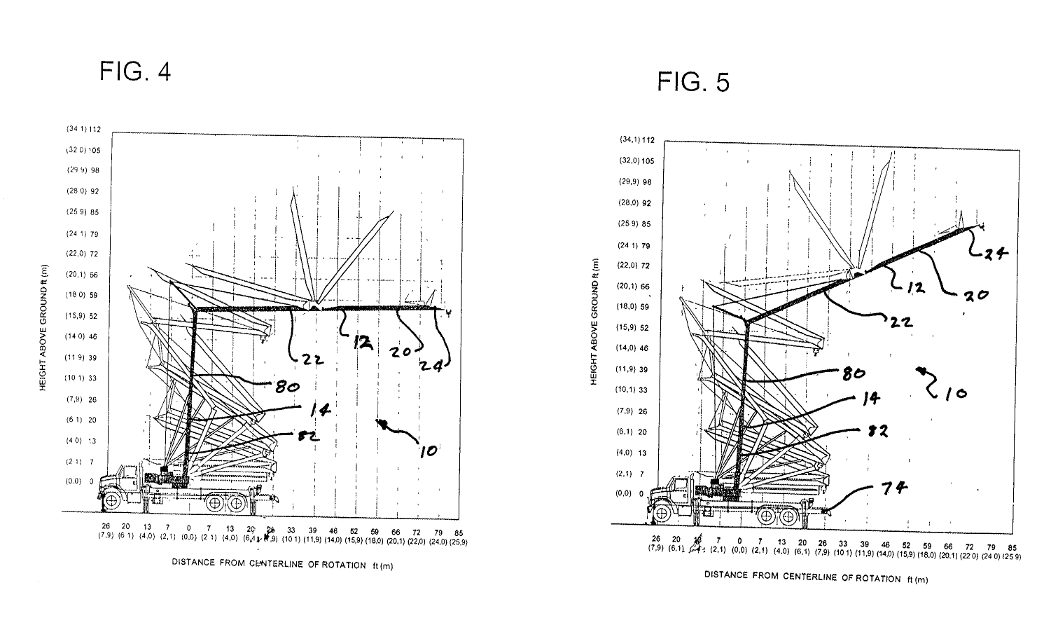

Folding and unfolding of the jib 12 is accomplished by the use of hydraulic cylinders connected between adjacent sections of the jib 12. For example, a hydraulic jib tip cylinder 26 is connected between the jib tip 24 and the forward jib section 20 in such a manner so that retraction of the hydraulic jib tip cylinder 26 causes the jib tip 24 to swing upwards past vertical and back on to the top of the forward jib section 20 (see FIGS. 4 and 5). A main hydraulic jib cylinder 28 is similarly connected between the forward jib section 20 and the rearward jib section 22 in such a manner so that retraction of the main hydraulic jib cylinder 28 causes the forward jib section 20 to swing upwards past vertical and back on to the top of the rearward jib section 22 (see FIGS. 4 and 5). Extension of the hydraulic cylinders 26 and 28 causes the jib 12 to unfold. In the preferred embodiment shown, cams and/or lever arms 30 are connected to the hydraulic cylinders 26 and 28 so as to provide the correct range of motion for the folding and unfolding of the jib 12. In addition, the preferred embodiment utilizes a short connecting section 32 between the forward jib section 20 and the rearward jib section 22. The connecting section 32, which includes a pivotal connection at each end thereof, permits the forward jib section 20 to be folded on top of the rearward jib section 22 without disconnecting these two sections from each other (see FIG. 3). In particular, the connecting section 32 provides a pair of spaced apart joints along the lower cords 16 of the jib 12 between the forward jib section 20 and the rearward jib section 22. The hydraulic cylinders 26 and 28 are connected via hoses (not shown) to a hydraulic system 34 on the rotating bed 36.

As shown in FIG. 1, when the mobile tower crane 10 is in the fully erected, normal operational position, the jib 12 is oriented in a nearly horizontal position. In the preferred embodiment shown, the jib 12 is oriented at an angle of 3° above horizontal, with the further most end of the jib 12 (i.e., the jib tip 24) positioned slightly above the end of the jib 12 connected to the mast 14. The jib 12 is held in this position by a jib tie 38 that is connected between the middle of the jib 12 and the rotating bed 36. As best seen in FIG. 1, the middle portion of the jib tie 38 is spaced away from both the jib 12 and the mast 14 by a strut 40. As appreciated by those knowledgeable in the art of tower cranes, the strut 40 permits the jib tie 38 to transfer vertical loads on the jib 12 to the rearward portion of the rotating bed 36. The strut 40 is also used to laterally support the forward jib section 20 when it has been folded back on top of the rearward jib section 22. During normal crane operations, the jib tie 38 is in tension and the strut 40 is in compression. In the preferred embodiment shown, the jib tie 38 comprises a wire rope and the strut 40 comprises a tubular steel member. In addition, the strut 40 is pivotally connected to the rearward jib section 22 so as to permit the strut 40 to be folded for transport (see FIG. 3).

As shown in FIG. 2, the jib 12 of the preferred embodiment of the mobile tower crane 10 can also be placed into a 20° offset work position. This is accomplished by shortening the length of the jib tie 38 so as pivot the strut 40 downwardly, which in turn causes the jib 12 to be pivoted upwardly. The 20° offset work position provides a greater height at the end of the jib 12 so as to increase the vertical working range of the mobile tower crane 10 (i.e., to permit loads to be raised or lowered a greater distance). Of course, it should be appreciated that the lifting capacity of the mobile tower crane 10 may be reduced while in the 20° offset work position.

A trolley 42 is connected to the underside of the jib 12 and is moveable along the length thereof (FIG. 1 shows the position of the trolley 42 at multiple locations along the length of the jib 12). In particular, the trolley comprises a frame having a plurality of wheels 44 that are configured to roll along tracks in or on the lower cords 16 of the jib 12. One or more trolley cables (not shown) are connected between the trolley 42 and a motor driven winch (not shown) on the rearward jib section 22. Movement of these trolley cables by the motor causes the trolley 42 to move back-and-forth along the length of the jib 12. A load hoist line 46 passes through the trolley 42 and is wrapped or reeved around a hoisting block 48 suspended beneath the trolley 42. Movement of the load hoist line 46, which is accomplished with a load hoist line drum (not shown) in a section of the lower mast 82, raises and lowers the hoisting block 48. A load hoist hook 50 is connected to the hoisting block 48, and is used to connect to loads being lifted by the mobile tower crane 10. The configuration and operation of these various load lifting components and machinery is well know to those skilled in the art of tower cranes.

The mast 14 is pivotally supported on a rotating bed 36. The pivotal connection between the lower end of the mast 14 and the rotating bed 36 is oriented horizontally so as to permit the mast 14 to be rotated through a vertical angle (relative to the rotating bed 36). As will be explained in more detail below, the pivotal connection between the mast 14 and the rotating bed 36 permits the mast 14 to be folded and collapsed on top of the rotating bed 36 for transport (as shown in FIG. 3).

In the preferred embodiment shown, the mast 14 comprises a tubular steel structure having a generally octagonal cross-section. The tubular steel structure of the mast 14 is preferably manufactured from two formed plates that have been welded together longitudinally (i.e., along the length of the mast 14). However, and as appreciated by those knowledgeable in the art of cranes, various cross-sections and types of structures can be utilized depending on the design and loading parameters of the mast 14. For example, the mast 14 could comprise a rectangular or triangular cross-section, or could comprise a lattice-type structure similar to that of the jib 12. The mast 14 of the preferred embodiment is 50 ft. in length.

The mast 14 preferably comprises two sections that can be folded to reduce the overall length of the mast 14 (see FIG. 3). In particular, the mast 14 comprises an upper mast 80 and a lower mast 82, which may be folded together for transport (as shown in FIG. 3). In the preferred embodiment shown, the lower mast 82 is shorter than the upper mast 80 to thereby permit the lower mast 82 to remain connected to the rotating bed 36 when the mast 14 is folded for transport. In other words, because the lower mast 82 is pivotally connected to the forward end of the rotating bed 36 (which is near the mid-point of the mobile tower crane 10), and because the lower mast 82 folded down in front of the rotating bed 36 for transport, the lower mast 82 must be limited in length so as to not extend too far past the rear of the truck chassis 52 (see FIG. 3). On the other hand, since the upper mast 80 is folded on top of the lower mast 82 and the rotating bed 36 for transport, the upper mast 80 may be longer than the lower mast 82. In any event, the folded mast 14 is designed so as to be foldable within the boundaries of the folded jib 12 (see FIG. 3) so as to meet the roadway limitations discussed above.

Of course, it should be appreciated that a mast 14 having a shorter overall length (when fully erected) may not require any foldable sections to meet the above roadway limitations. Likewise, a mast 14 having a longer overall length may require more than two foldable sections to meet these same limitations, or to meet more restrictive roadway limitations. Alternatively, the mast 14 could comprise two or more telescopic sections, or a combination of telescopic and folding sections, that are collapsible and/or foldable to achieve the same result.

Folding and unfolding of the mast 14 is accomplished by the use of a hydraulic mast raise cylinder connected between the upper mast 80 and the lower mast 82. The hydraulic mast raise cylinder 54 is configured in such a manner so that retraction of the hydraulic mast raise cylinder 54 causes the upper mast 80 and the lower mast 82 to fold together in a horizontal position on top of the rotating bed 36 (see FIGS. 4 and 5). Extension of the hydraulic mast raise cylinder 54 causes the mast 14 to unfold. In the preferred embodiment shown, cams and/or lever arms 56 are connected to the hydraulic mast raise cylinder 54 so as to provide the correct range of motion for the folding and unfolding of the mast 14. The hydraulic mast raise cylinder 54 is connected via hoses (not shown) to the hydraulic system 34 on the rotating bed 36.

During the unfolding or mast 14 raising operation, the hydraulic mast raise cylinder 54 works in combination with the mast support 58 (described below) to both unfold and raise the mast 14 from the stored position to the fully erected position. In particular, and as best seen in FIGS. 4 and 5, as the hydraulic mast raise cylinder 54 is extended to unfold the mast 14, the mast support 58 causes the unfolding mast 14 to swing upwards towards vertical.

As shown in FIG. 1, when the mobile tower crane 10 is in the fully erected, normal operational position, the mast 14 is then held in a generally vertical orientation by the mast support 58 in combination with the hydraulic mast raise cylinder 54. The mast support 58 is connected between the rearward portion of the rotating bed 36 and an intermediate point on the mast 14. In particular, the mast support 58 is connected to a lower portion of the upper mast 80. As appreciated by those knowledgeable in the art of tower cranes, the mast support 58 holds the mast 14 in the operational position by transferring the forces applied to the top of the mast 14 by the jib 12 to the rearward portion of the rotating bed 36. The mast support 58 preferably comprises a tubular steel member capable of transferring both compressive and tensile forces between the mast 14 and the rotating bed 36.

In the preferred embodiment shown, the lower end of the mast support 58 is pivotally connected to a frame 60 that is welded to the top of the rotating bed 36. The frame 60, which comprises a pair of struts, raises the pivotal connection at the lower end of the mast support 58 above the rotating bed 36. This prevents the mast support 58 from interfering with the machinery 62 on the rotating bed 36 when the mast support 58 is folded on top of the mast 14 and placed in a stored position for transport (as shown in FIG. 3).

The rotating bed 36 is rotatably supported on a sub-frame 64 mounted on the truck chassis 52. The sub-frame 64 comprises a torsionally resistant, rigid four-plate design. The rotatable connection between the rotating bed 36 and the sub-frame 64 comprises a slewing ring 66. In the preferred embodiment, the slewing ring 66 is mounted to the upper surface of the sub-frame 64, and comprises a series of gear teeth (not shown) spaced around the outside face of the slewing ring 66. A pinion gear (not shown) connected to a gear reducer (not shown) and a motor 68 on the rotating bed 36 is configured to engage the gear teeth on the slewing ring 66. As the pinion gear is rotated by the motor 68, the pinion gear moves along the gear teeth on the slewing ring 66 to thereby rotate the rotating bed 36 relative to the sub-frame 64. Rotation of the rotating bed 36 causes the mast 14, and in turn the jib 12, to rotate about a vertical axis through the center of the slewing ring 66.

The rotating bed 36 also supports the power equipment 70 for the mobile tower crane 10. The power equipment 70 includes the hydraulic system 34 for extending and retracting the various hydraulic cylinders on the jib 12 and the mast 14. The power equipment 70 also includes the controls for operating the motors used to move the trolley 42, to raise the hoisting block 48, and to rotate the pinion gear. In the preferred embodiment, the controls for operating the mobile tower crane 10 include both a hard-cabled control station and radio remote controls.

Counterweights 72 are positioned on the rearward end of the rotating bed 36. The counterweights 72 are designed to balance the load on the rotating bed 36 that is generated by the weight of the mast 14, the jib 12, and the rated load, since the center of gravity of these components is in front of the rotating bed 36. In other words, the counterweights 72 apply a moment force to the rotating bed 36 that at least partially opposes the moment force applied to the rotating bed 36 by the mast 14, the jib 12, and the rated load. However, it should be noted that in the preferred embodiment, at least a portion of the moment force applied to the rotating bed 36 by the mast 14, the jib 12, and the rated load, is carried by the sub-frame 64 and transferred to the outriggers 76 (described below). Depending on the configuration of the mast 14 and jib 12, additional counterweights (not shown) may be added to or removed from the rotating bed 36.

The sub-frame 64 is mounted on the truck chassis 52 of a commercially available truck 74. As used herein, a “commercially available truck” is defined as a truck that is designed and manufactured for multiple purposes, and is in contrast to a vehicle that is designed and manufactured for a specific purpose. In other words, a “commercially available truck” is a vehicle that is designed and manufactured independent of the design of the tower crane (i.e., the components supported by the sub-frame 64). Moreover, a “commercially available truck” is ordinarily (although not necessarily) designed and manufactured by a company or entity that is different from the company or entity that designs and manufactures the tower crane components. By way of example, the commercially available truck 74 used in the mobile tower crane 10 of the preferred embodiment might also be used as a cargo transport vehicle. This is in contrast with a vehicle frame that is designed and manufactured specifically for use as part of a mobile tower crane. As a consequence, commercially available trucks are generally less expensive and time consuming to manufacture.

In the preferred embodiment shown, the commercially available truck 74 is a Sterling model 9501 having a 410 horsepower engine and compatible drive train components. Alternatively, the commercially available truck 74 is a Sterling model 7501 having a 300 horsepower engine and compatible drive train components. Both of these Sterling models are standard production trucks used for a wide variety of body installations having a variety of functions. Of course, other commercially available trucks from other truck manufacturers can also be utilized.

In the preferred embodiment shown, the mobile tower crane 10 includes a self-contained power source for supplying the electrical power required for crane operations. In particular, the electrical power required for the power equipment 70 on the mobile tower crane 10 is supplied by a generator 84 mounted to the underside of the truck chassis 52 (or alternatively mounted to the sub-frame 64). The generator 84 is preferably a 25 KW model that provides three-phase, 480 volt, 60-hertz AC electrical power. The generator 84 is driven by a power take off unit 86 connected to the transmission of the commercially available truck 74. The rotational driving force is transferred from the power take off unit 86 to the generator 84 by a drive shaft 88 connected between there between. The drive shaft includes a shear hub (not shown) to protect the power take off unit 86 and the transmission of the commercially available truck 74 in the event of a failure in the generator 84.

The generator 84 of the preferred embodiment is designed to operate a constant rotational speed of approximately 1800 rpm's. This requires regulation of the engine speed of the commercially available truck 74, which is achieved by sending the appropriate electronic signal to the engine control module (not shown) on board the commercially available truck 74.

In the preferred embodiment shown, the sub-frame 64 includes outriggers 76 for stabilizing the mobile tower crane 10 while in the operational position. Each of the outriggers 76 typically comprises a hydraulic jack 78 that can be extended so as to contact the ground and support the mobile tower crane 10. The outriggers 76 transfer the weight and crane loads directly to the ground, and prevents the suspension components on the truck chassis from causing the sub-frame 64 to move. In other words, the outriggers 76 provide the sub-frame 64 with a stable working platform. In the preferred embodiment, the outriggers 76 are extendable outwardly from the sub-frame 64 so as to increase the stability thereof, the total width being equal to 19 ft. 10 in. (as measured between the vertical axis of the outriggers 76 on either side of the sub-frame 64).

In the preferred embodiment, the outriggers 76 must be deployed before the power take off unit 86 (described above) can be engaged. In other words, the generator 84 cannot be “powered up” until the mobile tower crane 10 has been supported by the outriggers 76. This prevents the inadvertent erection of the mobile tower crane 10 prior to stabilizing the sub-frame 64. In the preferred embodiment, the outriggers 76 must be extended to either of two positions before erecting the mobile tower crane 10, i.e., the fully extended position of 19 ft. 10 in., or an intermediate position of 13 ft. 7 in. Of course, the loading capacity and range of motion of the mobile tower crane 10 may be limited by the position of the outriggers 76.

As best shown in FIG. 1, the preferred embodiment of the mobile tower crane 10, when erected in the normal operational position, has a working radius of approximately 82 ft. and a working height of 54 ft. 1 in. The working radius is defined as the horizontal distance between the axis of rotation of the rotating bed 36 and the load hoist hook 50 when the trolley 42 is at the end of the jib 12. The working height is defined as the vertical distance between the ground and the load hoist hook 50 when the trolley 42 is at the end of the jib 12. When the mobile tower crane 10 is erected in the 20° offset work position shown in FIG. 2, then the working height is increased to 75 ft. 5 in. Of course, the working radius of the mobile tower crane 10 is less than 82 ft. when erected in the 20° offset work position.

As best shown in FIG. 3, the preferred embodiment of the mobile tower crane 10 can be collapsed for transport so as to comply with applicable State and U.S. Department of Transportation Federal Highway and Bridge limitations. For example, most States, including California, limit the overall length of fixed chassis vehicles to no more than 40 ft. Most States also limit the overall height of a vehicle to 13 ft. 6 in. The preferred embodiment of the mobile tower crane 10, when collapsed for transport, has an overall length of 39 ft. 10 in. and an overall height of 13 ft. 5 in., and consequently meets these dimensional limitations for fixed chassis vehicles. In addition, the preferred embodiment of the mobile tower crane 10 has an overall width (outriggers 76 retracted) of 8 ft. 0 in., which similarly meets U.S. Department of Transportation Federal Highway and Bridge limitations and most, if not all, State roadway limitations. Of course, the overall length, height and width of the mobile tower crane 10 of the present invention could be further reduced to meet more restrictive dimensional limitations, or to satisfy other criteria.

In addition to the above dimensional restrictions, the U.S. Department of Transportation, Federal Highway Administration, publishes Bridge Formula Weights that are used for determining the maximum vehicle axle loads for most federal and State roadways and bridges. In particular, tandem-axle vehicles are required to have a front axle loading below 20,000 lbs. and a rear tandem loading below 34,000 lbs. The mobile tower crane 10 of the preferred embodiment, when collapsed for transport, has a front axle loading of approximately 19,600 lbs. and a rear tandem load of approximately 33,500 lbs., and consequently meets these vehicle axle load limitations. Of course, the axle loads of the mobile tower crane 10 of the present invention could be further reduced to meet more restrictive vehicle axle load limitations, or to satisfy other criteria.

FIGS. 4 and 5 are schematic drawings showing the mobile tower crane 10 in various stages of erection between the transport position shown in FIG. 3 and the normal operational position shown in FIG. 1, and between the transport position and the 20° offset work position shown in FIG. 2, respectively. FIGS. 4 and 5 also show the dimensional clearances required during the raising or collapsing procedure.

In the preferred embodiment, the erection of the mobile tower crane 10 is carried out automatically by the manipulation of a single control. In particular, and after the outriggers have been deployed, the operator initiates a crane erection command sequence through the manipulation or activation of a single control on either the hard-cabled control station or on the radio remote control panel. A logic chip or computer subsequently sends signals to the various motors and hydraulic systems on the mobile tower crane 10 so as to cause the mast 14 and jib 12 to unfold and self-erect according to pre-determined sequence as shown in either FIGS. 4 or 5.

It should be appreciated that the apparatus and methods of the present invention are capable of being incorporated in the form of a variety of embodiments, only a few of which have been illustrated and described above. The invention may be embodied in other forms without departing from its spirit or essential characteristics. For example, the mobile tower crane of the present invention could be a top slewing type tower crane wherein the slewing ring is disposed between the jib and the top of the mast. The present invention could also be embodied in mobile tower cranes having other types of configurations. The described embodiments are therefore to be considered in all respects only as illustrative and not restrictive, and the scope of the invention is, therefore, indicated by the appended claims rather than by the foregoing description. All changes that come within the meaning and range of equivalency of the claims are to be embraced within their scope.

1. A mobile tower crane for lifting a load, said mobile tower crane comprising a jib supported by a mast, said jib being swingable about a vertical axis of said crane, said mobile tower crane further comprising a hoisting block for lifting the load, said hoisting block being suspended from a trolley by a load hoist line, said trolley being movable along a length of said jib, wherein said mobile tower crane further comprises a commercially available truck for supporting said mast.

2. The mobile tower crane according to claim 1 wherein the mast and the jib can be collapsed on top of the commercially available truck for transport between job sites.

3. The mobile tower crane according to claim 2 wherein, when said mast and jib have been collapsed on top of the commercially available truck for transport, said commercially available truck comprises an overall dimension and axle loading that is in compliance with U.S. Department of Transportation Federal Highway and Bridge limitations.

4. The mobile tower crane according to claim 2 wherein, when said mast and jib have been collapsed on top of the commercially available truck for transport, said commercially available truck comprises an overall dimension and axle loading that is in compliance with State highway and bridge limitations.

5. The mobile tower crane according to claim 2 wherein, when said mast and jib have been collapsed on top of the commercially available truck for transport, said commercially available truck comprises an overall length ≦40 feet, and overall height ≦13.5 feet, a front axle loading ≦20,000 lbs., and a rear tandem axle loading ≦34,000 lbs.

6. The mobile tower crane according to claim 2 wherein said mast is supported on a rotating bed, said rotating bed being supported by a slewing ring, a sub-frame and a plurality of outriggers mounted on a chassis of the commercially available truck.

7. The mobile tower crane according to claim 2 wherein said mast and said jib each comprise a plurality of sections so as to permit said mast and said jib to each be collapsed or folded into a shorter overall length.

8. The mobile tower crane according to claim 1 wherein said commercially available truck is manufactured for use in non-crane applications.

9. The mobile tower crane according to claim 1 wherein said commercially available truck comprises a truck model 9501 manufactured by Sterling.

10. The mobile tower crane according to claim 1 wherein said commercially available truck comprises a truck model 7501 manufactured by Sterling.

11. The mobile tower crane according to claim 1 wherein the mast and the jib are self-erecting.

12. The mobile tower crane according to claim 1 further comprising an electrical generator for generating electrical power for crane operations, said electrical generator being connected to an engine mounted in said commercially available truck by a drive shaft and a power take off unit, said engine also being used to drive said commercially available truck.

13. The mobile tower crane according to claim 12 wherein the electrical power generated by said electrical generator comprises three-phase, 480 volt, and 60-hertz electrical power.

14. A mobile tower crane for lifting a load, said mobile tower crane comprising a tower crane portion mounted on a commercially available truck, said commercially available truck comprising a truck chassis, said tower crane portion comprising a rotating bed rotatably supported on said truck chassis by a slewing ring, a mast supported on said rotating bed, a jib supported by said mast, a trolley movably supported by said jib, a hoisting block suspended from said trolley by a load hoist line, and a load hoist hook connected to said hoisting block, said jib being swingable about a vertical axis of rotation of said rotating bed so as to move said load hoist hook in a horizontal arc about the vertical axis of rotation, said trolley being movable along said jib so as to move said load hoist hook in a horizontal direction perpendicular to the vertical axis of rotation, said hoisting block being movable relative to said trolley so as to move said load hoist hook in a vertical direction parallel to the vertical axis of rotation, wherein said tower crane portion is collapsible to a transport position on top of the commercially available truck for transport between job sites.

15. The mobile tower crane according to claim 14 wherein, when said tower crane portion has been collapsed to the transport position, said commercially available truck comprises an overall dimension and axle loading that is in compliance with U.S. Department of Transportation Federal Highway and Bridge limitations.

16. The mobile tower crane according to claim 14 wherein, when said tower crane portion has been collapsed to the transport position, said commercially available truck comprises an overall dimension and axle loading that is in compliance with State highway and bridge limitations.

17. The mobile tower crane according to claim 14 wherein, when said tower crane portion has been collapsed to the transport position, said commercially available truck comprises an overall length ≦40 feet, and overall height ≦13.5 feet, a front axle loading ≦20,000 lbs., and a rear tandem axle loading ≦34,000 lbs.

18. The mobile tower crane according to claim 14 wherein said mast and said jib each comprise a plurality of sections so as to permit said mast and said jib to each be folded into a shorter overall length when said tower crane portion has been collapsed to the transport position.

19. The mobile tower crane according to claim 14 wherein said commercially available truck is manufactured for use in non-crane applications, said non-crane application not including said crane tower portion.

20. The mobile tower crane according to claim 19 wherein said commercially available truck comprises a truck model 9501 manufactured by Sterling.

21. The mobile tower crane according to claim 19 wherein said commercially available truck comprises a truck model 7501 manufactured by Sterling.

22. The mobile tower crane according to claim 14 wherein the mast and the jib are self-erecting.

23. The mobile tower crane according to claim 14 further comprising an electrical generator for generating electrical power for crane operations, said electrical generator being connected to an engine mounted in said commercially available truck by a drive shaft and a power take off unit, said engine also being used to drive said commercially available truck during transport between job sites.

24. The mobile tower crane according to claim 23 wherein the electrical power generated by said electrical generator comprises three-phase, 480 volt, and 60-hertz electrical power.
